(19) United States
(12) Patent Application Publication
(10) Pub. No.: US 2017/0138736 A1
(43) Pub. Date: May 18, 2017

(54) Management of Event Information for Interested Users

(71) Applicant: SalesApproach, Inc.d/b/a Where2 Interactive, Sudbury, MA (US)

(72) Inventor: Jeffrey Mitchell Simon, Sudbury, MA (US)

(73) Assignee: SalesApproach, Inc.d/b/a Where2 Interactive, Sudbury, MA (US)

(21) Appl. No.: 14/190,228

(22) Filed: Feb. 26, 2014

(51) Int. Cl. G01C 21/00; G06F 3/0484; G06T 11/20; G06F 17/30; H04W 4/02

(52) U.S. Cl. CPC G01C 21/00; G06F 17/30312; H04W 4/02; G06T 11/206; G06F 17/30864; G06F 3/04842

(57) ABSTRACT

A computer-implemented method performs event-centric navigation and planning for a user including: compiling a database of known events related to a field of endeavor in a database server computer; receiving input data from the user identifying at least one of: a selected date and a selected locus; identifying for selection a group of events based on the input data received from the user; selecting an event within the group from the database of known events; planning a trip to the selected event; and displaying a navigation aid to the selected event. Methods include coordinating the activity of event attendees includes: recording in a database an indication of interest in an event by a potential attendee; and geo-locating in real time another potential attendee of the event. Methods include displaying graphically representing geo-located event activity during a selected timeframe, comprising: representing concentrations of events as different colors; coloring a map of a large geographic area with the different colors according to numbers of events occurring during the selected timeframe within regions of the large geographic area, so as to form a heat map. Methods includes selecting information and displaying the information to a user, comprising: receiving an input from the user identifying an event of interest to the user; selecting a characteristic of events upon which an operator desires to base information display; selecting information for display based on a value of the characteristic for the identified event; and displaying the information to the user.

### BACKGROUND

The present invention relates generally to methods of managing event information for interested users. Some aspects of the invention relate to managing such information for geo-located events, while other aspects relate to managing such information for events lacking geo-locations, such as online webinars and the like.

### SUMMARY

According to aspects of one embodiment of the invention, a computer-implemented method of performing event-centric navigation and planning for a user includes: compiling a database of known events related to a field of endeavor in a database server computer; receiving input data from the user identifying at least one of: a selected date and a selected locus; identifying for selection a group of events based on the input data received from the user; selecting an event within the group from the database of known events; planning a trip to the selected event; and displaying a navigation aid to the selected event. According to some variations, the method may further include displaying points of interest along the planned trip relevant to the field of endeavor and the input received from the user. According to yet further variations, displaying points of interest may further include: displaying options for food, lodging, transportation, arts and entertainment, camping, and businesses related to the field of endeavor. Planning may further include: preparing a ground-based route via at least one of: street, trail, waterway, and rail; or planning may further include: preparing an air route including routing and filing of flight plans. Preparing a route plan may factor in whether additional points of interest or events can be included by judicious selection of breaks and fuel stops. Planning may further include identifying a time at which to begin travel in order to arrive at a desired time in advance of event time, for example accounting for at least one of: ticketing time, hotel check-in time, and travel transfer time, when identifying the time at which to begin travel, or accounting for at least one of: time to travel different segments via different transportation modes, or accounting for weather, or accounting for traffic.

According to aspects of another embodiment of the invention, a computer-implemented method of coordinating the activity of event attendees includes: recording in a database an indication of interest in an event by a potential attendee; and geo-locating in real time another potential attendee of the event. In a variation, geo-locating further includes retrieving GPS positioning information from a device identified with the other potential attendee. Geo-locating may also further include recording in the database an indication of the location of the other potential attendee, responsive to a data input by the potential attendee; retrieving the indication of the location of the other potential attendee; and displaying to the potential attendee the location of the other potential attendee. In another variation, geo-locating may include retrieving air traffic control information concerning an aircraft corresponding to a travel plan of the other potential attendee. The method may further include matching plural users to ride-share based on common interest and nearby geo-location, for example, wherein the common interest includes experience attributes. The experience attributes may include at least one of flight instructor, motorcycle instructor, and special license holder. In another variation, the method includes displaying to the potential attendee a location of the aircraft corresponding to the travel plan of the other potential attendee. Geo-locating may further include tracking and displaying locations of plural other potential attendees while they travel to the event, or tracking and displaying locations of plural other potential attendees who have indicated interest in the event. Such a variation may also further include establishing a communication channel with one of the tracked plural other potential attendees. Geo-locating may further include displaying profile information about the plural other potential attendees, for example, indicating by use of graphical indications on a map of locations of the plural other potential attendees, the profile information. The graphical indications may represent at least one of: an event, a geographic location, a type of vehicle, an interest, an age, a club membership, an organization membership, and experience attributes including flight instructor, motorcycle instructor, and special license holder.

According to yet other aspects of embodiments of the invention, a computer-implemented method of displaying graphically representing geo-located event activity during a selected timeframe, includes representing concentrations of events as different colors; and coloring a map of a large geographic area with the different colors according to numbers of events occurring during the selected timeframe within regions of the large geographic area, so as to form a heat map. Forming the heat map may further include storing sequences over time of the heat map; and playing the sequences as animations over various time periods. This variation may further include identifying trending of event-concentrations; and graphically representing the identified trending on the heat map.

Yet other aspects of embodiments of the invention include a computer-implemented method for collecting information about events including automated, on-line searching, gathering, normalization, categorization and cataloging of event data via web searching and screen scraping. In a variation, embodiments may include deploying an automated, intelligent web crawler constructed and adapted to identify and extract event data from web pages; and interpreting gathered event data to identify at least one of: an event category, an event type, an organization, a venue, a cost to attend, an event date, and an event time. In another variation, the event data includes event data for non-geo-located events.

According to yet other aspects of embodiments of the invention, a computer-implemented method of selecting information and displaying the information to a user includes: receiving an input from the user identifying an event of interest to the user; selecting a characteristic of events upon which an operator desires to base information display; selecting information for display based on a value of the characteristic for the identified event; and displaying the information to the user. In a variation, the characteristic may be at least one of: event location, event category, and event type. In a further variation, the method includes applying a logical rule to the value of the characteristic to produce a result; and wherein selecting based on the value of the characteristic includes using the result of applying the logical rule. In yet a further variation, selecting further includes applying a logical rule to prior registration information of a user to produce a representation of prior behavior; and selecting additionally based on the representation of prior behavior. In some variations, the event has no geo-localization. In some variations, the characteristic includes an interest category, such as at least one of: automobiles, airplanes, motorcycles, trucks, sailboats, powerboats, fishing, guns, weapons, knives, history, cycling, wine, beer, spirits, cigars, sports, science fiction, comics, and fantasy. In yet another variation, the method may include generating a notification message concerning events of interest to a user based on the selecting based on the representation of prior behavior; and transmitting to the user, the generated notification message. In a further variation transmitting includes sending the generated message by one of: an instant message service, a social network message service, a calendar entry in a calendar subscription, and an email message.

In the following description, reference is made to the accompanying drawings, which form a part hereof, and in which are shown example implementations. It should understood that other implementations are possible, and that these example implementations are intended to be merely illustrative.

### DESCRIPTION OF THE DRAWINGS

FIG. 1 is a block diagram of a computer network system in which the invention may be practiced.

FIG. 2 is a flow chart illustrating aspects of the invention.

FIG. 3 is a flow chart illustrating further aspects of the invention.

FIG. 4 is a flow chart illustrating yet further aspects of the invention.

FIG. 5 is a flow chart illustrating further aspects of the invention.

FIG. 6 is a flow chart illustrating even further aspects of the invention.

### DETAILED DESCRIPTION

The following section provides an example of an operating environment in which a method of managing event information for interested users can be embodied.

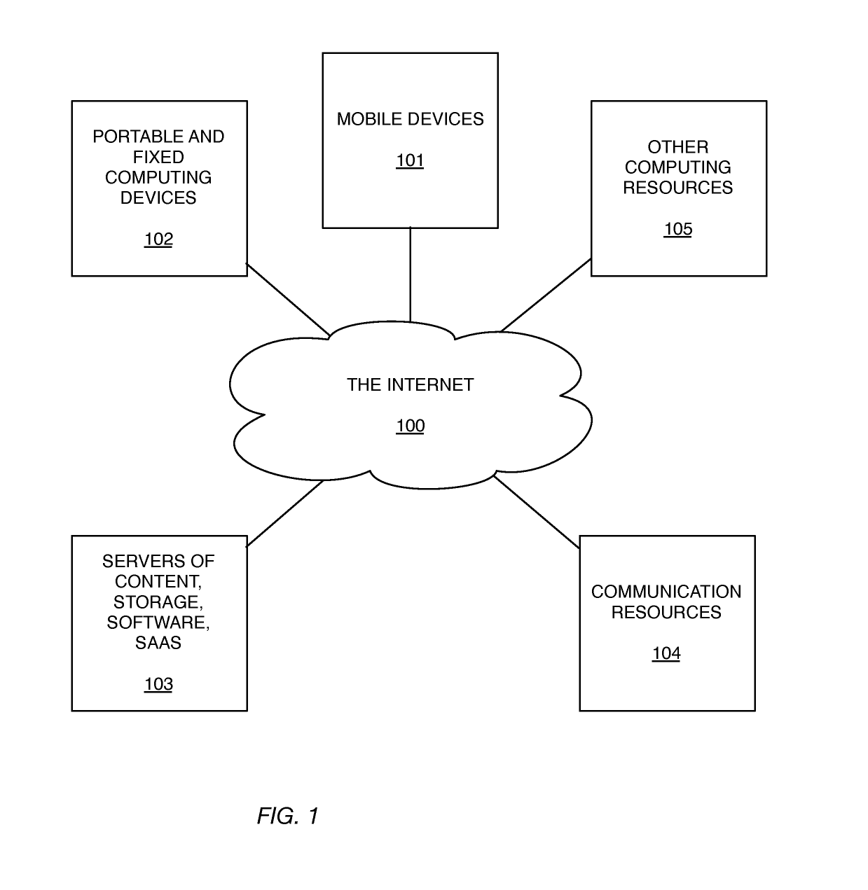

Referring to FIG. 1, a computer hardware environment in which the method can be practiced is described. The exemplary computer hardware environment can be generally described as a computer network of any suitable size and scope that supports and incudes the operational elements and architecture relied on by the exemplary methods and apparatus described below. Some common operational elements and architectural features are now described in connection with FIG. 1.

Various computing devices are interconnected for communication through a computer network having any suitable hardware configuration, such as the global Internet computer network, 100. The computing devices can include one or more of any of the following devices: mobile devices, 101; portable and fixed computing devices, 102; servers, 103, of content, software, software as a service (SaaS), storage, and other resources; communication resources, 104, such as interconnects, switches, and routers; and other computing resources, 105. Mobile devices, portable and fixed computing devices, switches, routers, and servers generally include a central processing unit (CPU), microprocessor, micro-controller, or similar element that executes software instructions to accomplish the tasks for which they are employed. Local instructions and local data are stored in suitable forms of computer storage and computer memory, including both transitory and non-transitory media and/or signals. Devices may include input peripherals, display peripherals, and other peripherals that are either integrated into the device or connected to the device.

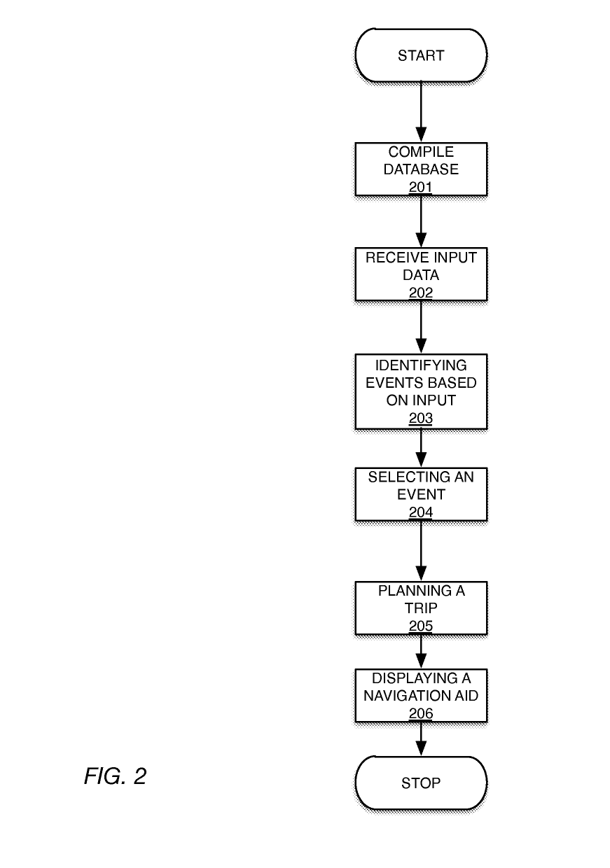

Given this context, an example implementation of the general operation of the method of managing event information for interested users will be described in more detail in connection with FIGS. 2-6.

According to some embodiments of the invention, one or more server systems collect information about interest groups; user groups; and events related to individuals' interests, product ownership, and the like. Interest groups, user groups, sponsors, organizers, and the like, conventionally maintain lists of events that they organize or sponsor or that they consider might be of interest to their members. For example, an organization devoted to ownership of light aircraft may organize a fly-in event, or an equipment swap. A car club may organize rallies, shows, and equipment swaps. According to aspects of the present invention, all kinds of event information of interest to individuals based on event characteristics such as activity type, product type, date, time, and location are identified, collected, and captured, across different groups, sponsors, organizers, etc. Event information can alternatively be identified, collected, and captured, for example using conventional software tools for crawling, scraping, and cataloging event-related content stored and accessed through web servers connected to the internet. Event information can be identified, collected, and captured manually by information workers who seek relevant content. The cataloged, event-related content is loaded into a database accessible by users having access through the Internet to the database server, or accessible by users of web-enabled applications or mobile apps having access through the Internet to the database server.

A suite of mobile apps and/or SaaS web server tools can be provided to process the database to list or map all the events according to the users' preferences. Preferences can include activity type, interest area, date, time, location (including virtualized events taking place via the Internet), so the user can identify and network with people who are attending particular events, planning on attending particular events, or even en route to particular events.

Apps and web tools can preferably identify groups of events meeting user-specified criteria, identify groups of users travelling common routes or to common events so as to point out socialization opportunities, including at points of common interest to users along the route.

Having now described the general operation of aspects of the invention, a more specific example will now be described.

Mobile apps and web portals can be sponsored by or otherwise supported by any entity interested in supporting an activity type. These can be targeted to an event or type of event, but need not be tied to the event organizer. Sponsors can support or sponsor the listing service rather than a particular event or event listing; however, the sponsorship can also be targeted to specific events or event types.

Apps, web portals for accessing the database, and databases can gather all the events pertaining to a business or industry type. For example, apps or portals that gather all the medical grand rounds and medical conferences in one place; or, apps that gather all the continuing legal education listings in one place can be targeted at individuals with those interests. An offeror of a product or service in a field of interest can raise their status by purchasing the naming rights for the app or portal in their field.

Aspects of embodiments of the invention can be realized as a mobile app or computer software designed to run on any networked computer tailored by or for organizations that have access to relevant data, users, advertisers, and/or a potential revenue stream that would take advantage of the novel social networking and other features of the invention.

Back-office software operating on or with access to the database server can gather data useful for marketing purposes through the system. Events are conventionally targeted at markets on seasonal, or cyclical, models based on demographic analyses of markets and regions. In contrast, back-office software according to aspects of embodiments of the invention can collect over a period of time, such as twelve months, events from a geographical area such as the US, for example, and create a heat map, in which colors or other visual variations applied to a geographical map signify concentrations of events across the region. Sequential heat maps can be produced for sequential points in time, across the region, showing the pattern over time of the events collected. By playing the sequential heat maps as an animation over the year, new marketing insights can be gained. For example, data can be filtered on various parameters, such as event type, such as user activities or sales activities to generate new insights regarding variations across regions and time intervals based on actual behavior of actual users, rather than the behavior of a presumed demographic. Virtual events, webinars, and other live on-line events can be treated and tracked the same way as physical events by providing similar tools for finding events, participants, and socialization opportunities to users. Tracking data can then be collected in the background as users search for, plan, and attend various online activities.

Mobile devices, and other suitable devices including geo-location services, are particularly useful to track event attendees. Then, individuals can socialize with each other at the events they attend, or along the way to the events they attend, including at points of interest relevant to the activities of the event attendees. By tracking the search and travel plans of attendees, individuals can be introduced to others with common interests, common travel plans, and common attendance plans.

Several specific processes illustrating aspects of embodiments of the invention are now discussed in connection with FIGS. 2-5.

The flow chart of FIG. 2 shows a computer-implemented method of performing event-centric navigation and planning for a user. The method includes, step 201, compiling a database of known events related to a field of endeavor in a database server computer; step 202, receiving input data from the user identifying at least one of: a selected date and a selected locus; step 203, identifying for selection a group of events based on the input data received from the user; step 204, selecting an event within the group from the database of known events; step 205, planning a trip to the selected event; and, step 206, displaying a navigation aid to the selected event.

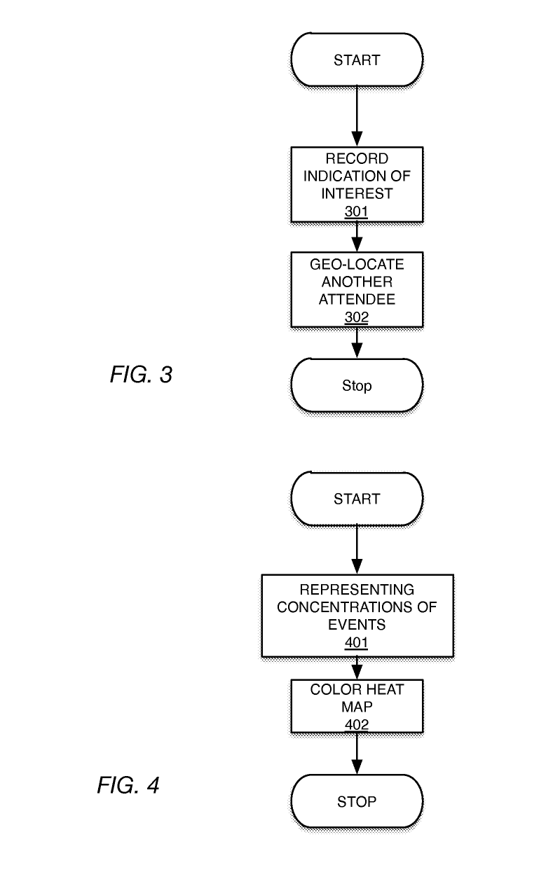

As shown in the flow chart of FIG. 3, an aspect of the invention is a computer-implemented method of coordinating the activity of event attendees. This aspect of the invention includes, step 301, recording in a database an indication of interest in an event by a potential attendee; and, step 302, geo-locating in real time another potential attendee of the event. Once the steps of this aspect have been completed, the potential attendees can be identified to one another, so that they can meet along the way to the event of interest, or otherwise coordinate their activities in association with attending the event of interest. In this way, new friendships and acquaintanceships can be formed around the attendance at the event of interest.

The flow chart of FIG. 4 shows a computer-implemented method of displaying graphically representing geo-located event activity during a selected timeframe. This aspect of the invention includes, step 401, representing concentrations of events as different colors; and, step 402, coloring a map of a large geographic area with the different colors according to numbers of events occurring during the selected timeframe within regions of the large geographic area, so as to form a heat map.

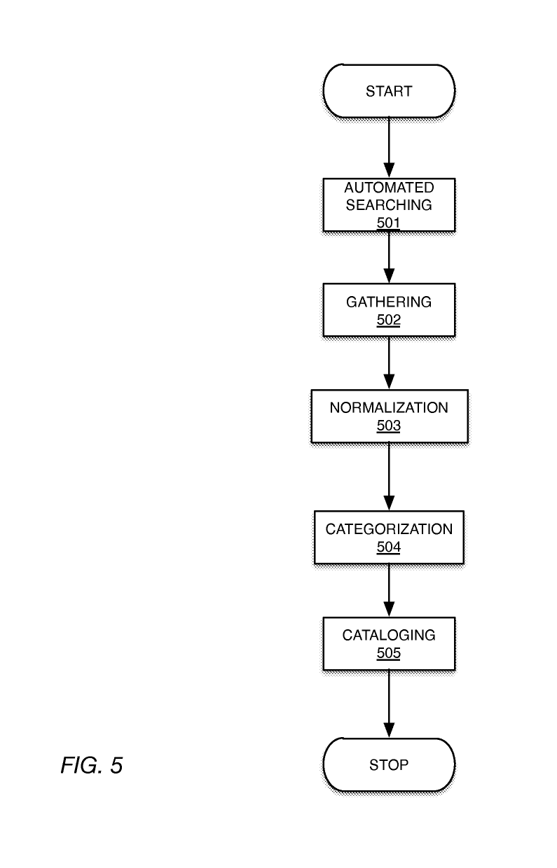

The flow chart of FIG. 5 shows a computer-implemented method for collecting information about events. This aspect of the invention includes automated, on-line searching, step 501; gathering, step 502; normalization, step 503; categorization, step 504; and cataloging, step 505; of event data. On-line searching and gathering, steps 501 and 502, can be performed via web searching and screen scraping, as well as other web-based methods such as monitoring of RSS feeds, direct database access, use of APIs to access, search, and gather information from a variety of sources. Normalization, step 503, is required because data from different sources may not have the same format or be otherwise comparable when it is later desired to identify relevant events according to criteria by which users express their preferences. Once normalized, step 503, events can be categorized, step 504, and cataloged, step 505, for easy search and access by users.

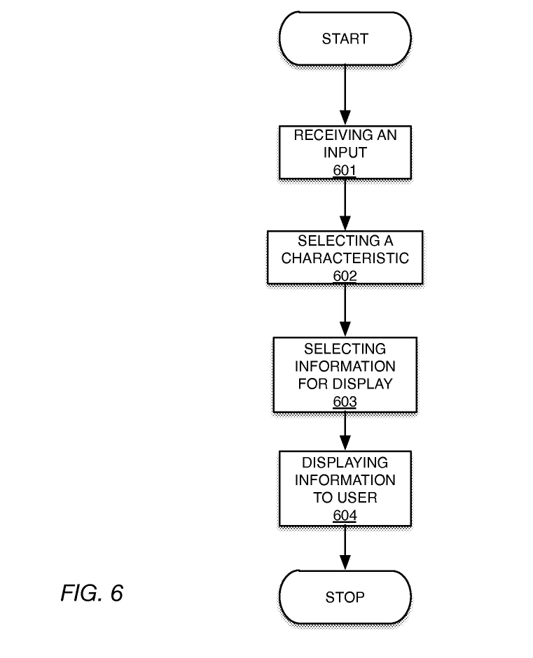

The flow chart of FIG. 6 shows a computer-implemented method of selecting information and displaying the information to a user. This aspect of the invention includes, step 601, receiving an input from the user identifying an event of interest to the user; step 602, selecting a characteristic of events upon which an operator desires to base information display; step 603, selecting information for display based on a value of the characteristic for the identified event; and, step 604, displaying the information to the user.

Conventional social networking systems lack data acquisition that is not crowd sourced. Conventional systems also lack the mapping features such as heat-mapping of the activity, or mapping of individuals filtered by event attendance so individuals with common interests and travel schedules can get to know each other. Tying navigation to events, rather than locations, is also lacking in conventional technology.

Knowing each user's location, mode of transport, and location of event permits embodiments of the invention to compute and suggest timing, routing, and socialization options of maximum interest to users and/or sponsors, which are then communicated to those users and/or sponsors. For example, the data can be passed to apps tailored for flight planning for users who are pilots interested in fly-in events, or tailored for float planning for users who are sailors interested in sailing rallies and regattas.

What is claimed is:

1. A computer-implemented method of performing event-centric navigation and planning for a user, comprising:
providing to the user a mobile computer interface constructed and arranged to receive staged event criteria inputs from the user and to display human-centric navigation information to the user;
compiling a database of known staged events related to a field of endeavor in a database server computer;
receiving input data from the user identifying at least one of: a selected date and a selected locus;
identifying for selection a group of staged events based on the input data received from the user, from which the user selects an identified staged event within the group from the database of known events;
planning a route to the selected event, preferring routing options favorable to meeting others interested in the field of endeavor; and
displaying the planned route to the selected event.

2. The computer-implemented method of claim 1, further comprising:
displaying points of interest along the planned trip relevant to the field of endeavor and the input received from the user.

3. The computer-implemented method of claim 2, displaying points of interest further comprising:
displaying options in categories of food, lodging, transportation, arts and entertainment, camping, and businesses related to the field of endeavor.

4. The computer-implemented method of claim 1, the planning a trip to the selected event further comprising:
preparing a ground-based route via at least one of: street, trail, waterway, and rail.

5. The computer-implemented method of claim 1, the planning a trip to the selected event further comprising:
preparing an air route including routing and filing of flight plans.

6. The computer-implemented method of claim 1, further comprising:
preparing a route plan that factors in whether additional points of interest or events can be included by judicious selection of breaks and fuel stops.

7. The computer-implemented method of claim 1, the planning a trip to the selected event further comprising:
identifying a time at which to begin travel in order to arrive at a desired time in advance of event time.

8. The computer-implemented method of claim 7, further comprising:
accounting for at least one of: ticketing time, hotel check-in time, and travel transfer time, when identifying the time at which to begin travel.

9. The computer-implemented method of claim 7, further comprising:
accounting for at least one of: time to travel different segments via different transportation modes.

10. The computer-implemented method of claim 7, further comprising:
accounting for weather.

11. The computer-implemented method of claim 7, further comprising:
accounting for traffic.

12. A computer-implemented method of coordinating the activity of event attendees, comprising:
recording in a database an indication of interest in an event by a potential attendee; and
geo-locating in real time another potential attendee of the event.

13. The computer-implemented method of claim 12, geo-locating further comprising:
retrieving GPS positioning information from a device identified with the other potential attendee.

14. The computer-implemented method of claim 12, geo-locating further comprising:
recording in the database an indication of the location of the other potential attendee, responsive to a data input by the potential attendee;
retrieving the indication of the location of the other potential attendee; and
displaying to the potential attendee the location of the other potential attendee.

15. The computer-implemented method of claim 12, geo-locating further comprising:
retrieving air traffic control information concerning an aircraft corresponding to a travel plan of the other potential attendee.

16. The computer-implemented method of claim 12, further comprising:
matching plural users to ride-share based on common interest and nearby geo-location.

17. The computer-implemented method of claim 16, wherein the common interest includes experience attributes.

18. The computer-implemented method of claim 17, wherein the experience attributes include at least one of flight instructor, motorcycle instructor, and special license holder.

19. The computer-implemented method of claim 15, further comprising:
displaying to the potential attendee a location of the aircraft corresponding to the travel plan of the other potential attendee.

20. The computer-implemented method of claim 12, geo-locating further comprising:
tracking and displaying locations of plural other potential attendees while they travel to the event.

21. The computer-implemented method of claim 12, geo-locating further comprising:
tracking and displaying locations of plural other potential attendees who have indicated interest in the event.

22. The computer-implemented method of claim 21, further comprising:
establishing a communication channel with one of the tracked plural other potential attendees.

23. The computer-implemented method of claim 21, geo-locating further comprising:
displaying profile information about the plural other potential attendees.

24. The computer-implemented method of claim 23, displaying profile information further comprising:
indicating by use of graphical indications on a map of locations of the plural other potential attendees, the profile information.

25. The computer-implemented method of claim 24, wherein the graphical indications represent at least one of: an event, a geographic location, a type of vehicle, an interest, an age, a club membership, an organization membership, and experience attributes including flight instructor, motorcycle instructor, and special license holder.

26. A computer-implemented method of displaying graphically representing geo-located event activity during a selected timeframe, comprising:
representing concentrations of events as different colors; and
coloring a map of a large geographic area with the different colors according to numbers of events occurring during the selected timeframe within regions of the large geographic area, so as to form a heat map.

27. The computer-implemented method of claim 26, further comprising:
storing sequences over time of the heat map; and
playing the sequences as animations over various time periods.

28. The computer-implemented method of claim 27, further comprising:
identifying trending of event-concentrations; and
graphically representing the identified trending on the heat map.

29. A computer-implemented method for collecting information about events, comprising:
automated, on-line searching, gathering, normalization, categorization and cataloging of event data via web searching and screen scraping.

30. The computer-implemented method of claim 29, further comprising:
deploying an automated, intelligent web crawler constructed and adapted to identify and extract event data from web pages; and
interpreting gathered event data to identify at least one of: an event category, an event type, an organization, a venue, a cost to attend, an event date, and an event time.

31. The computer-implemented method of claim 30, wherein the event data includes event data for non-geo-located events.

32. A computer-implemented method of selecting information and displaying the information to a user, comprising:
receiving an input from the user identifying an event of interest to the user;
selecting a characteristic of events upon which an operator desires to base information display;
selecting information for display based on a value of the characteristic for the identified event; and
displaying the information to the user.

33. The computer-implemented method of claim 32, the characteristic further comprising at least one of: event location, event category, and event type.

34. The computer-implemented method of claim 33, further comprising:
applying a logical rule to the value of the characteristic to produce a result; and wherein
selecting based on the value of the characteristic includes using the result of applying the logical rule.

35. The computer-implemented method of claim 34, selecting further comprising:
applying a logical rule to prior registration information of a user to produce a representation of prior behavior; and
selecting additionally based on the representation of prior behavior.

36. The computer-implemented method of claim 33, wherein the event has no geo-localization.

37. The computer-implemented method of claim 36, wherein the characteristic includes an interest category.

38. The computer-implemented method of claim 37, wherein the interest category includes at least one of: automobiles, airplanes, motorcycles, trucks, sailboats, powerboats, fishing, guns, weapons, knives, history, cycling, wine, beer, spirits, cigars, sports, science fiction, comics, and fantasy.

39. The computer-implemented method of claim 35, further comprising:
generating a notification message concerning events of interest to a user based on the selecting based on the representation of prior behavior; and
transmitting to the user, the generated notification message.

40. The computer-implemented method of claim 39, transmitting including sending the generated message by one of: an instant message service, a social network message service, a calendar entry in a calendar subscription, and an email message.
